(19) United States
(12) Patent Application Publication
(10) Pub. No.: US 2010/0033671 A1
(43) Pub. Date: Feb. 11, 2010

(54) Eye Goggles Having Opaque or Restricted View Lenses

(76) Inventor: Darius Campo, Sherman Oaks, CA (US)

Correspondence Address: ROBERT J. SCHAAP, Suite 188, 21241 Ventura Blvd, Woodland Hills, CA, 91362, US

(21) Appl. No.: 12/189,042

(22) Filed: Aug. 8, 2008

(51) Int. Cl. G02C 7/16

(52) U.S. Cl. 351/43; 351/45

(57) ABSTRACT

Improved eye goggles for underwater use and having lenses which are either opaque or vision restricted. Goggles of this type are effective for use in games, particularly children's games, in which one party is required to close his eyes and find another. These goggles ensure that the party who is to close his or her eyes does so and in like manner, it protects the eyes of the party who is required to close his eyes but attempts to peak or inadvertently opens his or her eyes while under water.

### BACKGROUND OF THE INVENTION

1. Field of the Invention

This invention relates to new and useful improvements in eye goggles and more particularly to eye goggles in which the lenses are either opaque or partially opaque such that vision is restricted or limited.

2. Brief Description of Related Art

In many children's games, and particularly in the game known as “Marco Polo” one child is required to close his eyes, but nevertheless locate one or more others in a swimming pool. In an effort to cheat in the game, some children will attempt to open their eyes under water in order to determine if one or more others is in close proximity. This is particularly the case in the game of “Marco Polo”. One child closes his or her eyes and attempts-to locate the presence of another by sound.

In many cases, children tend to cheat in these games and slightly open their eyes or squint under water in order to determine if another one or more of the players is in close proximity. Not only is this a violation of the rules of the game, but with sufficient chlorine content in the swimming pool, it can be harmful to the eyes of the party who opens his or her eyes under water.

There are numerous U.S. patents teaching of various types of swimming goggles such as, for example, U.S. Pat. No. 6,470,500 to Sung, U.S. Pat. No. 4,447,914 to Jannard, U.S. Pat. No. 5,711,035 to Haslbeck, U.S. Pat. No. 5,502,844 to Alvarado.

There also have been a proposal to use opaque eye pieces in tanning glasses as for example, that device taught in U.S. Pat. No. 6,074,935 to MacDonald. The tanning glasses actually include transparent glass frame, a nose piece, ear pieces and lenses. However, a hook and loop fashioning material crosses the lens in front of the eyes and holds opaque eye caps which are adapted to cover the eyes. These glasses are designed to actually protect the eyes by preventing damage to the eyes from exposure to light.

It is, therefore, highly desirable to provide a pair of goggles or water glasses which cover the eyes of one or more of the participants of a game and preclude vision or otherwise materially impair vision. The goggles can be constructed in a variety of ways in accordance with those techniques used for fabricating goggles having transparent lenses. Goggles of this type are useful in other games and in other underwater activities.

### OBJECTS OF THE INVENTION

It is, therefore, one of the primary objects of the present invention to provide a pair of goggles for use in a swimming pool environment and which includes opaque or partially restricted vision lenses therein.

It is another object of the present invention to provide a pair of eye goggles which can be used in any under water environment in which opaque or partially restricted vision lenses are incorporated therein.

It is a further object of the present invention to provide a pair of eye goggles of the type stated which can be manufactured at a very low cost but which are highly efficient in operation.

It is an additional object of the present invention to provide a method for engaging in an under-water pool game in which one or more of the players is required to periodically close his or her eyes and which will preclude or limit vision in the event that the player does open his or her eyes, or in the event that the player does inadvertently open his or her eyes.

With the above another objects in view my invention resides in the novel features of form construction, arrangement and combination in parts presently described and pointed out in the claims.

### BRIEF SUMMARY OF THE INVENTION

Eye goggles or swimming glasses or swimming goggles which have opaque lenses completely precluding view, or otherwise, which have vision restrictive lenses, such that it is difficult to view the presence of another or an object under water.

In accordance with the present invention, there is provided a pair of goggles which may be formed of a somewhat resilient rubberized like material with a band or strap capable of extending about the rear of the head of a wearer with the goggles extending over the eyes of the user. The band itself may be elastic and the eye pieces have a fair amount of elasticity. Notwithstanding the eye pieces hold lenses which are opaque or, otherwise, which will visually restrict the view of the user. The elasticity of the band and for that matter the eye piece holder will allow the entire pair of goggles to remain closely engaged with the head of the user and in water sealing-wise contact with the tissue surrounding the eyes. In this way, water will not seep into the eyes.

The invention provides eye glasses or goggles which can be used in an underwater environment and which includes lenses which are either opaque or vision restricted in some fashion. Preferably, in accordance with the present invention, it is desirable to use completely opaque lenses so that a player of a game in an underwater environment cannot locate another one of the players or an object. It should be understood that it is possible to use lenses which are not completely opaque, but which restrict vision, such that in underwater conditions it is quite difficult, if not impossible, to readily determine the presence of another player or a certain object.

The goggles of the invention preferably include a frame, even though formed of a flexible and bendable material, has a pair of eye pieces connected by a nose bridge, and a head band which is adapted to extend about the rear of the head of the user.

The whole construction is preferably formed of a flexible and foldable material, although any material of construction could be used. One type of construction would be that taught in U.S. Pat. No. 6,470,500 to Sung. In this case, there are no ear pieces, but rather there is a head band which is adapted to extend about the side and rear and the head of the wearer when the eye pieces are extended over the eyes of the user.

The lenses in this case are preferably completely opaque. For this purpose, a black coating can be spray painted over one or both sides of the lenses. Otherwise, the lenses may be integrally formed of an opaque material which precludes or reduces any vision through the goggles.

The headband and the eye pieces, as well as the nose piece is preferably formed of a flexible and bendable material, such that if one is contacted by another in an underwater environment, the bending of the frame will avoid the causing of injury to the wearer.

This present invention thereby provides a unique and novel swimming goggles having opaque or restricted view lenses, which thereby fulfills all of the above-identified objects and other objects which will become more fully apparent from a consideration of the forms in which it may be embodied. One of these forms is more fully illustrated in the accompanying drawings and described in the following detailed description of the invention. However, it should be understood that the accompanying drawings and this detailed description are set forth only for purposes of illustrating the general principles of the invention.

### BRIEF DESCRIPTION OF THE DRAWINGS

Having thus described the invention in general terms, reference will now be made to the accompanied drawings in which:

FIG. 1 is a perspective view of a pair of goggles constructed in accordance with and embodying the present invention;

FIG. 2 is a side elevational view of one form of lens in accordance with the present invention;

FIG. 3 is a side elevational view of a slightly modified form of lens which can be used in the present invention.

### DETAILED DESCRIPTION

Referring now in more detail and by reference characters to the drawings which illustrate a practical embodiment of the present invention, there is provided a pair of goggles 10 for wearing about the head of a user in an underwater environment.

The pair of goggles 10 is comprised of a frame 12 having a pair of eye pieces 14. Mounted within the eye pieces are lenses 16, as hereinafter described in more detail.

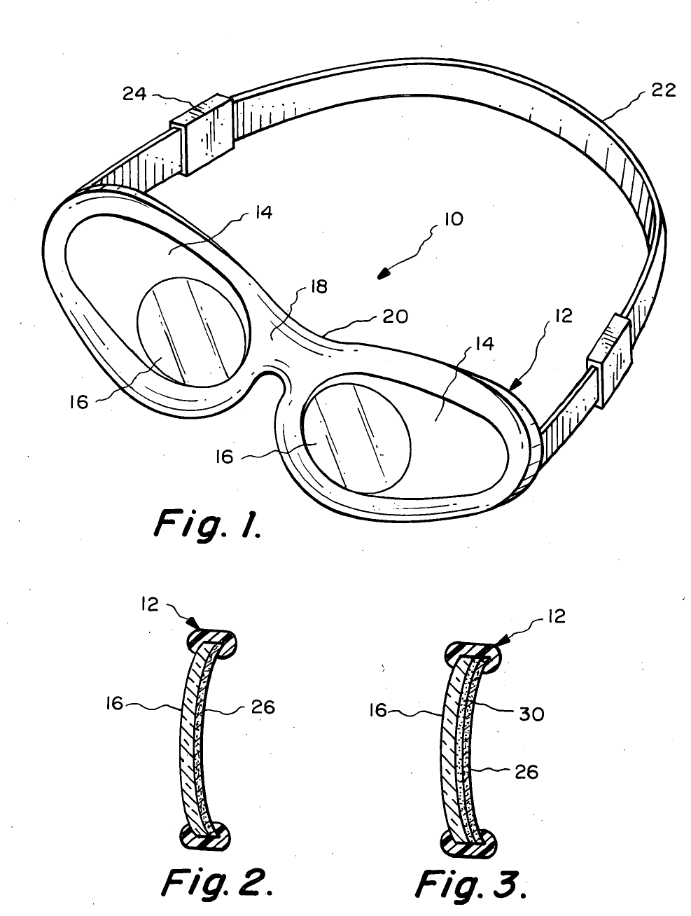

A nose piece 18 connects the two eye pieces 14. In this way, a band 22 connected to the outer ends of each of the two eye pieces 14, in the manner as shown in FIG. 1, will support the goggles on the head of the user. The nose piece 20 rests upon the bridge of the nose.

This entire construction is formed of a rubber-like material so that it still can be comfortable to the user. Moreover, the strap or band 22 is adjustable with buckles 24 in the manner as shown.

The eye pieces 16 are opaque and are preferably coated with a black or other dark coating 26 as shown in FIG. 2. In this way, it is virtually impossible to see through the coatings 26, thereby, precluding anyone from wearing the goggles with a direct eye sight.

It is also possible to use a modified form of lens 28 as shown in FIG. 3 and which may include particulate matter 30 incorporated therein to obscure the vision of a wearer. This is one form of creating a partially blocked opaque view.

It is also possible to use a pair of goggles of this type in an environment other than an under-water environment. For example, it may be desirable in some cases to protect the eyes of the wearer and at the same time engage in providing a handicap to the user. This handicap may be in a form of a visually restricted handicap. The present pair of goggles works ideally from that standpoint. Moreover, a pair of typical glasses having a frame with lenses of this type incorporated therein would also be highly effective in protecting the eyes of the user but nevertheless providing some restrictions to the view of the user.

Thus there has been illustrated and described a unique and novel swimming goggles having opaque or restricted view lenses, and which thereby fulfills all of the objects and advantages which have been sought. It should be understood that many changes, modifications, variations, and other uses and applications will become apparent to those skilled in the art after considering this specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. A pair of eye goggles adapted to extend over the eyes of a user in an underwater environment, said goggles comprising:
a) a frame having a pair of eye lens piece supporting sections;
b) a band extending outwardly from said frame for extending about at least a portion of the head of the user for holding the goggles on the user;
c) eye piece lenses which are either fully opaque or otherwise provided with matter therein to cause a substantially reduced visability through the lenses.

2. The pair of eye goggles of claim 1 further characterized in that:
a) said frame is formed of a flexible and bendable material so that the eye goggles are flexible and bendable.

3. The pair of eye goggles of claim 1 further characterized in that:
a) said lenses are also formed of a flexible and somewhat bendable material so that the lenses may bend somewhat and thereby partially overcome risks of cracking or other damage.

4. The pair of eye goggles of claim 1 further characterized in that:
a) said band is an elastic band to hold the frame tightly against the head of the user and thereby seal the frame around the eyes of the user.

5. The pair of eye goggles of claim 1 further characterized in that:
a) said eye piece lenses have a coating therein which renders them either opaque or with substantially reduced visability.

6. The pair of eye goggles of claim 1 further characterized in that:
a) said frame is formed of somewhat flexible material.

7. A pair of eye glasses adapted to extend over the eyes of a user and which can be used in a game environment to provide a handicap to the user, said goggles comprising:
a) a frame having a pair of eye lenses piece supporting sections;
b) an eyeglass support extending outwardly from said frame for extending along the temples of the user for holding the glasses on the head of the user; and
c) eye piece lenses which are either fully opaque or otherwise provided with matter therein to cause a substantially reduced visability through the lenses.

8. The pair of eye glasses of claim 7 further characterized in that:
a) said frame is formed of a plastic material having some structural integrity so that the eye glasses are engageable with the users head to hold the eye glasses on the head of the user.

9. The pair of eye glasses of claim 7 further characterized in that:
a) said lenses are formed of a flexible and somewhat bendable material so that the lenses may bend somewhat and thereby partially overcome risks of cracking or other damage.

10. The pair of eye glasses of claim 7 further characterized in that:
a) said eye glasses are in the form of eye goggles and said eyeglass support is an elastic band; and
b) said band is an elastic band to hold the frame tightly against the head of the user and thereby seal the frame around the eyes of the user.

11. The pair of eye goggles of claim 7 further characterized in that:
a) said eye piece lenses have a coating therein which renders them either opaque or with substantially reduced visability.

12. A method of fully or partially restricting view of a user of a pair of goggles adapted to extend over the eyes of a user in an underwater environment, said goggles comprising:
a) applying to the head of the user a frame of the goggles formed of a somewhat flexible material and having a pair of eye pieces;
b) adjusting a band connected to the frame for extending above at least a portion of the head of the user for holding the goggles on the user; and
c) providing eye pieces which are either fully opaque or otherwise provided in such manner with matter to cause a substantially reduced visability through the lens.

13. The pair of eye goggles of claim 12 further characterized in that said method further comprises:
a) adjusting said band so that said frame while flexible and bendable is tightly adherent about the eyes of the user.

14. The pair of eye goggles of claim 13 further characterized in that method further comprises:
a) providing said band with an elastic band to hold the frame tightly against the head of the user and thereby seal the frame around the eyes of the user.

15. The pair of eye goggles of claim 13 further characterized in that method further comprises providing said eye piece lenses with a coating therein which renders them either opaque or with substantially reduced visability.
